(19) United States
(12) Patent Application Publication
(10) Pub. No.: US 2002/0000142 A1
(43) Pub. Date: Jan. 3, 2002

(54) Arrangement for cutting off a projecting cover layer and method of coating plates

(76) Inventor: Udo Hanitzch, Bielefeld (DE)

Correspondence Address: Barnes & Thornburg, Franklin Tower, Bldg., Suite 500, 1401 Eye Street, N.W., Washington, DC, 20005, US

(21) Appl. No.: 09/892,609

(22) Filed: Jun. 28, 2001

(30) Foreign Application Priority Data
Jun. 29, 2000 (DE) 100 31 702.2

(51) Int. Cl. B26D 1/14

(52) U.S. Cl. 83/13; 83/167; 83/914

(57) ABSTRACT

An arrangement for cutting off the projection of a cover layer comprises a transport device which moves an object with cover layers projecting on the sides past the edges of the object relative to a cutting device. A cutting device has a rotating cutting edge which is guided along the edge. The cutting device has a rotating cutting wheel which is biased toward the edge. Such a cutting arrangement is used on a coating system for plates.

### BACKGROUND AND SUMMARY OF THE INVENTION

The present invention relates to an arrangement for cutting off a projecting cover layer and to a method of coating plates which are covered in a coating system by a cover layer whose borders project over the edges of the plates and are cut off.

In the case of coating systems of this type, a cover layer made of paper, plastic or other cuttable materials is applied to a plate web and is then hardened. The cover layer, which can be produced in different thicknesses, may be brittle or flexible. It is wider at the lateral edges than the plate web because, as a result of manufacturing tolerances in the material and process. After the coating, the projecting borders of the cover layer are cut off.

In the case of currently known methods for cutting off borders of the cover layer, the cover layer is either sawed, in which case a small foil projection at the longitudinal edges is left, or the carrier plate is cut, milled or ground simultaneously with the sawing of the cover layer. During the milling and grinding, a removal of material again takes place at the lateral edge of the carrier plate.

The trimming of the longitudinal edges in the case of the known coating systems has the disadvantage that the known cutting devices require relatively high expenditures. For the sawing on the opposite sides, two motors and, for the grinding or milling, even four motors are required for driving the cutting tools. Another disadvantage is that either a foil projection is left at the longitudinal edges, or the carrier plate is always machined at the lateral edges results in waste and dust which requires disposal. The plates must therefore also be produced with an overdimension. In addition, the known systems cannot compensate width tolerances but cut off the cover layer and/or the carrier plate always in the previously adjusted position.

It is therefore an object of the present invention to provide an arrangement for cutting off projection of a cover layer and a method for coating plates in the case of which the cover layer can be cut off with high precision and which can be mounted by simple devices in or behind a coating system. In addition, the occurrence of dust and waste materials is to be reduced.

This object is achieved by the present invention.

A rotating cutting edge is guided along the edge of the object. The cutting edge can at least partially move along with the object and the projecting cover layer, so that the relative speed between the cutting edge and the cover layer to be cut off is minimized. In the case of a more brittle cover layer, this prevents component parts from coming off the object. In addition, such a rotating cutting edge can be guided with little wear in a simple manner on a lateral edge of an object. In which case the plate-shaped object can be used as a cutting counter edge.

According to a preferred embodiment of the invention, the cutting device has a rotating cutting wheel which is arranged partially next to the edge of the object. As a result, the cutting edge can be used for cutting off the cover layer as well as for the guiding on the lateral edge of the object. In order to obtain a clean contact on the lateral edge, the cutting wheel can be prestressed toward the edge of the object with the projecting cover layer. As a result, plate-shaped objects can also be trimmed which have a diagonally or angularly extending lateral edge. In addition, manufacturing tolerances can be compensated more easily.

According to a preferred embodiment of the invention, the object is guided on the edge with the projecting cover layer, so that a sideways movement of the object outside certain tolerances is avoided. The sideways movement may cause damage to the cover layer on the cutting device. This guide is preferably elastic so that manufacturing tolerances during the manufacturing of the plate-shaped object can be compensated. The term plate-shaped object means in this case that the cover layer is applied at least in areas in a plane on the object; however, the objects can also be profiled, curve or shaped in a different manner.

According to a further development of the invention, a coating system is provided with an arrangement for applying a cover layer to the top side and/or the underside of a plate-shaped object, which have at least one arrangement according to the invention for cutting off a projecting cover layer on each side of the plate-shaped object. At least one suction device is provided on the coating system for removing a cut-off strip of the cover layer in a simple manner.

The above-mentioned object is also achieved by a method having the characteristic of claim 10. According to the method, first a cover layer is applied to a plate-shaped object, for example, a derived timber product web, with ends projecting at the side, which object is then transported to a cutting device having at least one cutting wheel. The cutting wheel is rotated such that, viewed in the transport direction, the cutting edge impacts diagonally from the front onto the cover layer and the area of the cover layer projecting beyond the lateral edge of the object is cut off.

According to a preferred embodiment of the method, the plate-shaped object is guided elastically on both sides and the projecting area of the cover layer is cut off at the opposite sides As a result, manufacturing tolerances on the plate-shaped object can be compensated better during the cutting-off of the cover layer.

Other objects, advantages and novel features of the present invention will become apparent from the following detailed description of the invention when considered in conjunction with the accompanying drawings.

### BRIEF DESCRIPTION OF THE DRAWINGS

FIG. 1 is a frontal view of a cutting device according to the invention; and

FIG. 2 is a schematic lateral view of a part of the cutting device of FIG. 1.

### DETAILED DESCRIPTION OF THE PREFERRED EMBODIMENTS

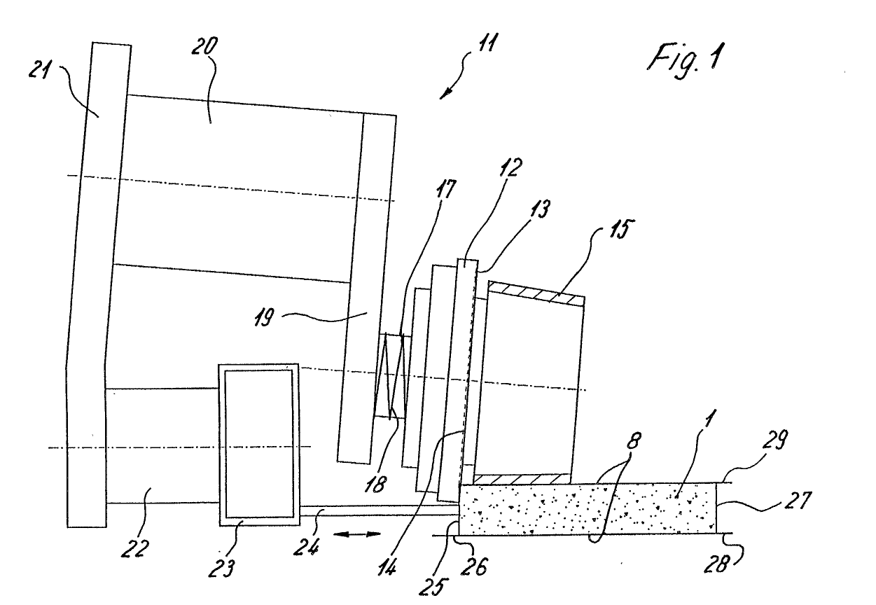

FIG. 1 is a detailed view of such a cutting device 11. The cutting device 11 has a cutting wheel 12 which is provided with a cutting edge 13 on the side facing the plate 1. The cutting wheels 12 of the cutting device 11 are made of hardened steel in order to be wear-resistant. Other materials, such as ceramics, can also be used.

The cutting edge 13 projects from the wheel 12. A recess 14 is made in the cutting wheel 12, so that, in the area of the recess 14, no contact exists between the plate 1 and the cutting wheel 12. The cutting wheel 12 is driven by a gummed wheel 15 which is guided on the top cover layer 8 of the plate 1. As a result of the transport movement of the plate 1, the wheel 15 rotates, which is guided with a slight pressure on the cover layer 8, and thus drives the cutting edge 13, which is guided along a lateral edge 25 of the plate 1. The rotating cutting wheel 12 is rotatably disposed on a holder 19 and is biased by a spring 18 toward the plate 1. The spring 18 is guided in a receiving device 17.

In order to be able to adjust the cutting device 11 to different plate widths, the holder 19 is movably held on a cutting wheel application device 20, so that the holder 19 can be adjusted along the cutting wheel application device 20. The cutting wheel application device 20 is connected with a frame 21.

In the lower area of the cutting device 11, an elastically constructed ruler 24 is provided which is fixed on a stop 23 received on a guide 22. The stop 23 is movably held on the guide 22 and ensures by way of the ruler 24, that the plate 1 is laterally guided within an area.

In the illustrated embodiment, the plate 1 is provided with a cover layer 8 on the top side and on the underside. The cover layer 8 has projecting ends 26, 28 and 29, the cutting-off of these ends 26, 28 and 29 taking place as illustrated in FIG. 1. Preferably, a cutting device 11 for cutting off the projecting area 29 is provided in a mirror-inverted manner on the opposite side 27 of the plate 1.

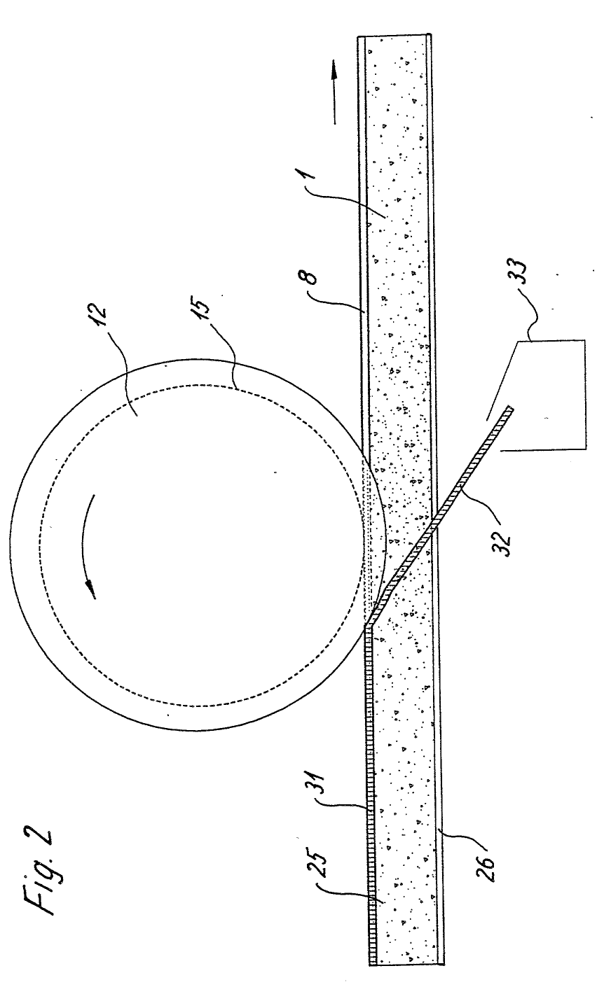

As illustrated in FIG. 2, the cutting wheel 12 rotates in the area of the plate 1 in the transport direction so that the relative movement between the cutting wheel 12 and the plate 1 is slight during the contact. The cutting edge 13 of the cutting wheel 12 impacts diagonally from above onto the projecting section 31 of the cover layer 8. The projecting section 31 is squeezed downward and the plate 1 which acts as a counterblade for the cutting edge 13 to shear the projecting section 31.

The cut-off strip 32 of the cover layer 8 can be removed by a suction device 33.

The cutting wheel 12 may be arranged with the axis of rotation of the cutting wheel at an angle with respect to the perpendicular line of the transport direction. Thus, the leading area of the cutting wheel 12 which first comes in contact with the cover layer 8 is arranged slightly closer to the edge 25 than the rearward trailing area of the cutting wheel 12. As a result, it prevents the lateral edge 25 from damaging the rearward trailing area of the cutting wheel 12.

In the case of the coating system according to the invention, four cutting devices 11 may be provided, each for cutting off a projecting section of the cover layer 8. In this case, the upper and lower cutting devices 11 can be applied offset with respect to one another in order to guide the plate 1 successively through the individual cutting devices 11 The cutting devices 11 are a vertically adjustable in order to be able to move through different plate thicknesses as well as horizontally adjustable.

Although the present invention has been described and illustrated in detail, it is to be clearly understood that the same is by way of illustration and example only, and is not to be taken by way of limitation. The spirit and scope of the present invention are to be limited only by the terms of the appended claims.

1. An arrangement for cutting off a projection of a cover layer on any object comprising:
a transport device which moves the object with a cover layer having a projection extending past an edge of the object; and
a cutting device having a rotating cutting edge which is guided along the edge of the object.

2. The arrangement according to claim 1, wherein the cutting device includes a rotating cutting wheel having a portion adjustment to the edge of the object.

3. The arrangement according to claim 2, wherein the cutting wheel is biased toward the edge of the object with the projection of the cover layer.

4. The arrangement according to claim 1, including a friction wheel guided on the cover layer of the object which drives the rotating cutting edge.

5. The arrangement according to claim 1, including guides for the edge of the object with projections of the cover layer.

6. The arrangement according to claim 5, wherein the guide has an elastic construction.

7. A coating system comprising:
a device for applying a cover layer to the top side or bottom side of a plate-shaped object; and
at least one cutting arrangement for cutting off a projection of the cover layer according to claim 1 on each side of the object.

8. The coating system according to claim 7, wherein the device applies a cover layer on both sides of the object and including a cutting arrangement for each side.

9. The coating system according to claim 7, including a suction device for removing the cut-off projection of the cover layer.

10. A method for coating plates comprising steps of:
applying a cover layer to a side of a plate-shaped object with ends of the cover layer projection past the side of the object;
transporting the object to a cutting device with at least one cutting wheel;
rotating the cutting wheel such that a cutting edge of the cutting wheel, viewed in the transport direction, impacts diagonally from above onto the cover layer; and
cutting off the area of the cover layer projecting past the edges.

11. The method according to claim 10, including elastically guiding the object on both sides; and
cutting off the projecting area of the cover layer on one or two opposite sides.

12. The arrangement according to claim 1, wherein the cutting device is adjustable horizontally.

13. The arrangement according to claim 1, wherein the cutting device is adjustable vertically.

14. The arrangement according to claim 1, including a cutting device at opposed edges of the object.

15. The coating system of claim 7, including a cutting device at opposed edges of the object.
